(19) United States
(12) Patent Application Publication
(10) Pub. No.: US 2022/0414100 A1
(43) Pub. Date: Dec. 29, 2022

(54) DECENTRALIZED QUERY EVALUATION FOR A DISTRIBUTED GRAPH DATABASE

(71) Applicant: Microsoft Technology Licensing, LLC, Redmond, WA (US)

(72) Inventors: Andrew J. CARTER, Kirkland, WA (US); Andrew RODRIGUEZ, Sunnyvale, CA (US); Yiming YANG, Danville, CA (US); Dhruvesh RATHORE, San Francisco, CA (US); Jiajun YAO, San Jose, CA (US); Tiance LIANG, Mountain View, CA (US)

(21) Appl. No.: 17/362,614

(22) Filed: Jun. 29, 2021

(51) Int. Cl. G06F 16/2453; G06F 16/2458; G06F 11/34

(52) U.S. Cl. CPC G06F 16/24545; G06F 16/24535; G06F 16/2471; G06F 11/3419

(57) ABSTRACT

The disclosed technologies are capable of decentralized query evaluation for a distributed graph database. In one technique, a query is divided into first and second sets of operations. The query comprises variables and constraints that correspond to at least two nodes and at least one edge of a graph in a graph database. The first set of operations for processing the query is assigned to multiple shards. A limit is communicated to the shards. The second set of operations for processing the query is executed. A list of completed operations is received from each shard. The lists of operations received from the shards are merged into a merged set of operations, which is used to determine whether query processing is finished. If query processing is not finished, then an updated limit is communicated to the shards; otherwise, query results are provided in response to the query.

### TECHNICAL FIELD

A technical field to which the present disclosure relates is decentralized query evaluation for distributed graph databases.

### BACKGROUND

A distributed data processing system provides a software framework for distributed storage and processing of data on a large scale. A distributed software framework may store portions of a database across many different computers on a network. The distributed data processing system coordinates data create, read, write, update, and delete operations, query operations, and computations across the network of computers.

There are different types of distributed database architectures including graph architectures and non-graph architectures. Examples of non-graph architectures include relational databases and key-value stores. In relational databases, data is organized according to a schema that includes tables and keys. A table stores data according to a logical arrangement of rows and columns. Keys are used to join data stored in different tables together. A structured query language (SQL) is used to construct and execute queries and to create, update, and manipulate tables and keys. A query result from a relational database may include data retrieved from different tables of the relational database.

Graph databases organize data using a graph data structure that includes a number of interconnected graph primitives. Examples of graph primitives include nodes, edges, and predicates, where a node stores data, an edge creates a relationship between two nodes, and a predicate is a semantic label assigned to an edge, which defines or describes the type of relationship that exists between the nodes connected by the edge.

A node of a graph database may correspond to a table, a subset of a table, or set of rows and columns of different tables of a non-graph database. Another example of a graph primitive is a particular portion of a graph or a sub-graph, such as a specific pair of nodes plus an edge by which the nodes are connected. A graph query language is used to construct and execute queries on the graph database and to create, update, and manipulate components of a graph database. With a graph database, query results include a subset of the graph stored in the graph database; e.g., one or more graph primitives.

A distributed system may be organized according to an arrangement of computers on a network that is designed for query throughput, response time, reliability, scalability, or performance. For example, a distributed system may include multiple data centers, where each data center resides at a different physical, geographic locations and each data center contains a complete copy of the database. Data centers may receive updated copies of the database through a replication process. Each data center may include multiple clusters of server computers, and each cluster or server computer may include one or more machines. In a distributed system, portions of a database or an index may be logically divided into shards. The different shards may be stored in the same machine or on different machines of the distributed system.

Indexes are used to quickly locate data in a database. Much like the index of a book identifies the pages on which particular words are printed, an index in the database context identifies the particular logical or physical storage locations of particular data items stored in the database. Indexes are created by a computer performing a build process. Generally, when data is added to or deleted from a database, or data in a database is updated, the indexes need to be correspondingly rebuilt. If data in a database changes frequently, then the indexes may need to be rebuilt more often. In a distributed system, database changes and index rebuilds may be performed on one computer and then propagated across the network of computers in the distributed system. For example, each shard of a distributed system may store a copy of an index.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram illustrating at least one embodiment of a computing system in which aspects of this disclosure may be implemented

FIG. 2 is a flow diagram of a process that may be used to implement a portion of the computing system of FIG. 1.

FIG. 3 is a flow diagram of a process that may be used to implement a portion of the computing system of FIG. 1.

FIG. 4A is a flow diagram of a process that may be used to implement a portion of the computing system of FIG. 1.

FIG. 4B illustrates an example of in-memory data structures that may be created and processed by a portion of the computing system of FIG. 1.

FIG. 5 is a flow diagram of a process that may be used to implement a portion of the computing system of FIG. 1.

FIG. 6 is a block diagram illustrating an embodiment of a hardware system, which may be used to implement various aspects of the computing system of FIG. 1.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Overview

Network-based software applications often store and process massive amounts of data. For example, connections network systems, such as social media applications and applications based thereon, may create, store, query, and perform complex operations on billions of data records every day.

Network-based software applications often include search functionality that allows users to enter queries to search for and retrieve data records that match the users' search criteria. An example of a search criterion is a keyword, such as an entity name, job title or skill. Examples of data records include user profiles, job postings, news feed items, and comments.

In applications that use or are based on a social graph, complicated operations may need to be performed to determine the correct set of query results. For instance, it may require several operations for the system to determine the first, second, or third-degree connections of an entity, particularly if the entity has a large number of connections. As another example, determining which of an entity's connections match a particular search query may require the system to perform a complicated set of operations, especially if the query contains multiple search criteria.

To improve the efficiency of performing these and other query processing operations, and to improve the speed at which accurate query results are retrieved from a database, a query may be divided into a set of sub-queries. The sub-queries may be individually evaluated by the query processor distributing the processing of the sub-queries across multiple shards of a distributed system. One or more of the machines in the distributed system may function as a broker, which coordinate the query processing activities of the shards.

Query planning as used herein may refer to a process of determining which operations need to be performed in order to resolve a query and the order in which those operations are to be performed. In distributed databases, query planning is generally done by the broker machine using a centralized, static query planning approach in which the broker machine performs all of the query planning, sends query processing requests to the shards, and the shards execute the requests naively and return their respective results to the broker machine.

In dynamic query planning, the query plan is not determined in advance. Instead, the query processing actions on the computational resources are evaluated (or costed) as they are performed and the next action is planned based on the evaluation that occurs after the performance of the previous action. Costing as used herein may refer to an estimation of a performance metric such as the processing time or amount of computational resources needed to complete an action.

It is a technical challenge to apply dynamic query planning techniques to a distributed database system. Dynamic query planning can be implemented in a single node environment because the single node performs the actions and therefore has all of the information it needs to do all of the costing. However, in a distributed system, the broker machine is unable to do the costing of actions that are distributed to the shards. The broker machine could communicate with the shards to obtain the costing information from the shards. However, frequent communications between the broker machine and the shards is also computationally expensive and could defeat the purpose of using a distributed system.

As described in more detail below, the disclosed technologies address these and other technical challenges by using a distributed and decentralized query planning approach in which certain query planning operations are assigned to the shards, such that the shards not only perform query execution operations but can do certain planning operations as well. For example, the broker machine may send an entire query out to all of the shards, receive cost estimates from each of the shards, divide the query into sub-queries based on the cost estimates received from the shards, and assign the sub-queries to itself and/or to the different shards based on those cost estimates. Using the disclosed technologies, assigning a sub-query to a shard may include assigning both query planning operations and query execution operations to the shard. In this way, both query planning and query execution may be distributed across both the broker machine and the shards of a distributed database system.

Another technical challenge that arises in a distributed database system is distributing the query processing work evenly so that the different shards do not have widely varying processing times to complete their tasks. Using the disclosed technologies, this challenge is addressed by the broker machine communicating a limit (e.g., in terms of processing time or number of operations) to the shards for a particular round trip of query processing and receiving from the shards information about the amount of query processing work the shards were able to perform within that limit on the round trip. If the broker machine determines that the query is not resolved after the round trip, the broker machine may adjust the limit and add another round trip using the adjusted limit. Round trip as used herein may refer to a combination of a request for query processing sent from the broker machine to the shards and a response to the query processing request received by the broker machine from the shards.

As used herein, node may refer to a node in a graph of a graph database and not to a computer in a network of computers. As used herein, node also may be used to refer to a sub-structure of an in-memory data structure, such as a table or an execution head. Table as used herein may refer to a logical table of an in-memory data structure, which organizes data according to rows and columns. Machine as used herein may refer to a physical machine, such as a server computer, or a virtual machine running on a server computer. A machine may include one or more processors, such as one or more microprocessors.

The above-described advantages and benefits are provided as examples. The disclosed technologies are not limited to these examples and may provide additional or different advantages and benefits than those described above.

### Example Use Case

The disclosed technologies may be described with reference to the example use case of path query evaluation for a distributed graph database in the context of a network application; for example, a social graph application such as a professional social network application.

### Other Use Cases

The disclosed technologies are not limited to social graph applications but can be used to perform path query evaluation for graph databases more generally. The disclosed technologies may be used by many different types of network applications in which queries are resolved using a graph database and path query evaluation is needed.

### Example Computing System

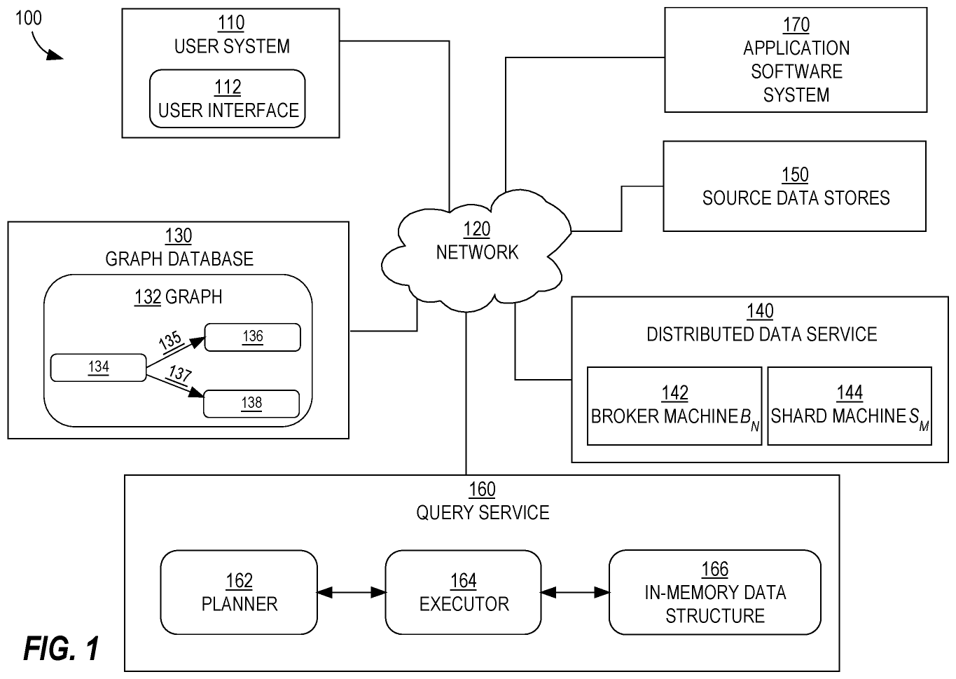

FIG. 1 illustrates a computing system in which embodiments of the features described in this document can be implemented. In the embodiment of FIG. 1, computing system 100 includes a user system 110, a network 120, a graph database 130, a distributed data service 140, a set of source data stores 150, a query service 160, and an application software system 170.

User system 110 includes at least one computing device, such as a personal computing device, a server, a mobile computing device, or a smart appliance. User system 110 includes at least one software application, including a user interface 112, installed on or accessible by a network to a computing device. For example, user interface 112 may be or include a front-end portion of application software system 170.

User interface 112 is any type of user interface as described above. User interface 112 may be used to input search queries and view or otherwise perceive output that includes data retrieved by query service 160 and/or produced by application software system 170. For example, user interface 112 may include a graphical user interface and/or a conversational voice/speech interface that includes a mechanism for entering a search query and viewing query results and/or other digital content. Examples of user interface 112 include web browsers, command line interfaces, and mobile apps. User interface 112 as used herein may include application programming interfaces (APIs).

Graph database 130 is a graph database that contains data that may be retrieved and/or manipulated by query service 160 to generate query results. In some implementations, portions of graph database 130 may be part of or accessed by or through another system, such as distributed data service 140. Data is ingested into graph database 130 and stored in a graph 132. Graph 132 includes any number of nodes, edges, and predicates; for example, nodes 134, 136, 138, edges 135, 137, and predicates, which are semantic labels for the edges.

Distributed data service 140 stores portions of graph database 130 in a distributed manner. Distributed data service 140 includes a number of data services 142, 144 that may perform different parts of a query processing task. Distributed data service 140 includes N broker machines 142 and M shards machines 144, where N and M are positive integers, B_{N} may refer to a single broker machine and S_{M} may refer to a single shard machine. As used herein, data service may refer to a physical, geographic grouping of machines, a logical grouping of machines, or a single machine. For example, a data service may be a data center, a cluster, a group of clusters, or a machine. A data service 142, 144 may store a complete copy of graph database 130 or only one or more portions of graph database 130.

Portions of a query processing task may be distributed across one or more individual data services of distributed data service 140, such as broker machines 142 and/or shard machines 144. To perform its portion of the query processing task, a particular data service of distributed data service 140 may create one or more in-memory data structures 166 and perform operations on the one or more in-memory data structures 166. An in-memory data structure 166 is created dynamically during query processing and is not stored statically. A particular data service, e.g., broker machine B_{N} 142 or shard machine S_{M} 144, of distributed data service 140 may include an instance of query service 160 or may be accessed by query service 160 during processing of a query.

Source data stores 150 store the source of truth data that is consumed by graph database 130. Source data stores 150 may be accessed by query service 160 via graph 130 and/or in-memory data structure 166 to retrieve and store query results. For example, using graph 130, intermediate query results may be retrieved from source data stores 150 and stored in in-memory data structure 166 during query processing.

Source data stores 150 may reside on at least one persistent and/or volatile storage device that may reside within the same local network as at least one other device of computing system 100 and/or in a network that is remote relative to at least one other device of computing system 100. Thus, although depicted as being included in computing system 100, portions of source data stores 150 may be part of computing system 100 or accessed by computing system 100 over a network, such as network 120.

Query service 160 interprets, plans and executes queries against graph database 130. In doing so, query service 160 may create or initiate the creation of one or more in-memory data structures 166. As another example, query service 160 may initiate one or more query planning operations by a query planner 162 and/or initiate the execution of one or more path execution operations on an in-memory data structure 166 by a query executor 164.

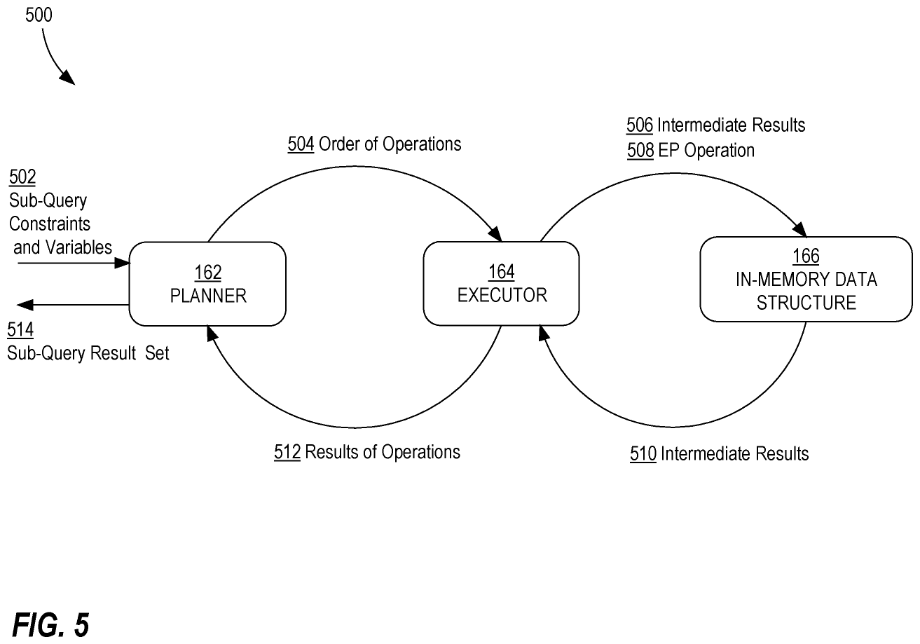

Portions of query service 160 may be part of or accessed by or through another system, such as one or more broker machines 142 and/or one or more shard machines 144 of distributed data service 140. For example, portions of query service 160 may be distributed to individual data services (e.g., broker machines 142 or shard machines 144) of distributed data service 140. Query service 160 may be implemented using a declarative query language such as datalog. Operation of query service 160 is described in more detail below with reference to FIG. 5.

Application software system 170 is any type of application software system that includes or utilizes functionality provided by query service 160. Examples of application software system 170 include but are not limited to connections network software, such as social media platforms, and systems that may or may not be based on connections network software, such as general-purpose search engines, job search software, recruiter search software, sales assistance software, advertising software, learning and education software, or any combination of any of the foregoing.

While not specifically shown, it should be understood that any of user system 110, graph database 130, distributed data service 140, source data stores 150, query service 160, and application software system 170 includes an interface embodied as computer programming code stored in computer memory that when executed causes a computing device to enable bidirectional communication with any other of user system 110, graph database 130, distributed data service 140, source data stores 150, query service 160, and application software system 170 using a communicative coupling mechanism. Examples of communicative coupling mechanisms include network interfaces, inter-process communication (IPC) interfaces and application program interfaces (APIs).

A client portion of application software system 170 may operate in user system 110, for example as a plugin or widget in a graphical user interface of a software application or as a web browser executing user interface 112. In an embodiment, a web browser may transmit an HTTP request over a network (e.g., the Internet) in response to user input that is received through a user interface provided by the web application and displayed through the web browser. A server running query service 160 and/or a server portion of application software system 170 may receive the input, perform at least one operation using the input, and return output using an HTTP response that the web browser receives and processes.

Each of user system 110, graph database 130, distributed data service 140, source data stores 150, query service 160, and application software system 170 is implemented using at least one computing device that is communicatively coupled to electronic communications network 120. Any of user system 110, graph database 130, distributed data service 140, source data stores 150, query service 160, and application software system 170 may be bidirectionally communicatively coupled by network 120. User system 110 as well as one or more different user systems (not shown) may be bidirectionally communicatively coupled to application software system 170 or query service 160.

A typical user of user system 110 may be an administrator of graph database 130, an administrator of a distributed data service 140, an administrator of application software system 170, or an end user of application software system 170. User system 110 is configured to communicate bidirectionally with any of graph database 130, distributed data service 140, source data stores 150, query service 160, and application software system 170 over network 120.

The features and functionality of user system 110, graph database 130, distributed data service 140, source data stores 150, query service 160, and application software system 170 are implemented using computer software, hardware, or software and hardware, and may include combinations of automated functionality, data structures, and digital data, which are represented schematically in the figures. User system 110, graph database 130, distributed data service 140, source data stores 150, query service 160, and application software system 170 are shown as separate elements in FIG. 1 for ease of discussion but the illustration is not meant to imply that separation of these elements is required. The illustrated systems, services, and data stores (or their functionality) may be divided over any number of physical systems, including a single physical computer system, and can communicate with each other in any appropriate manner.

Network 120 may be implemented on any medium or mechanism that provides for the exchange of data, signals, and/or instructions between the various components of computing system 100. Examples of network 120 include, without limitation, a Local Area Network (LAN), a Wide Area Network (WAN), an Ethernet network or the Internet, or at least one terrestrial, satellite or wireless link, or a combination of any number of different networks and/or communication links.

It should be understood that computing system 100 is just one example of an implementation of the technologies disclosed herein. While the description may refer to FIG. 1 or to “system 100” for ease of discussion, other suitable configurations of hardware and software components may be used to implement the disclosed technologies. Likewise, the particular embodiments shown in the subsequent drawings and described below are provided only as examples, and this disclosure is not limited to these exemplary embodiments.

### Example Query Evaluation Communications

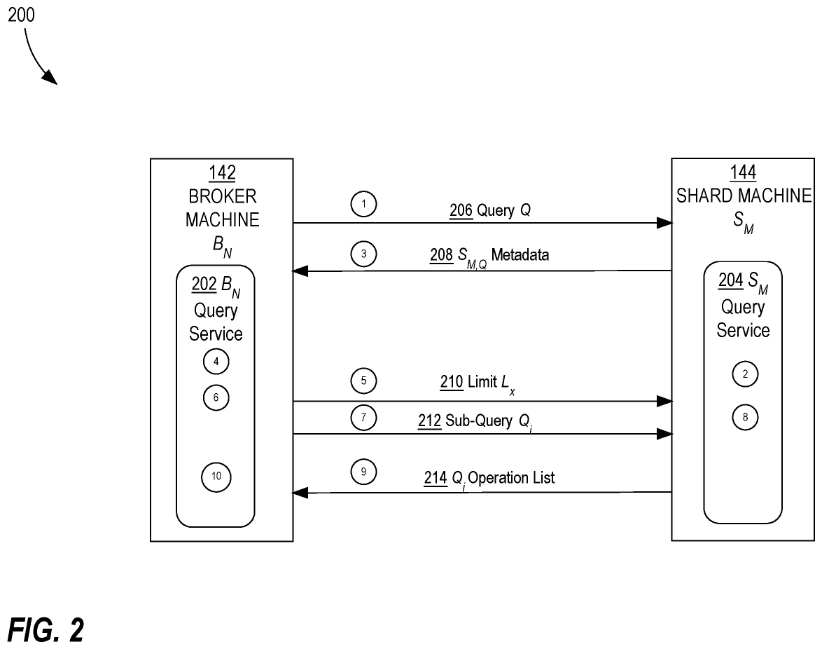

FIG. 2 is a flow diagram of a process that may be used to implement a portion of the computing system of FIG. 1. The operations of a flow 200 as shown in FIG. 2 can be implemented using processor-executable instructions that are stored in computer memory. For purposes of providing a clear example, the operations of FIG. 2 are described as performed by one or more machines of computing system 100, but other embodiments may use other systems, devices, or implemented techniques. More specifically, flow 200 illustrates operations that may be performed by, for example, portions 202, 204 of query service 160 that reside on a broker machine B_{N} 142 and a shard machine S_{M} 144, respectively, and an order in which those operations may be performed.

In step 1, broker machine B_{N} 142 executes an operation 206 that sends a query Q to shard machine S_{M} 144 and to others of the M shard machines (not shown) in distributed data service 140. Query Q may be a graph query that involves, for example, resolving an edge between two nodes of graph 132. Alternatively or in addition, query Q may be a declarative representation of a graph query that includes a set of variables and a set of constraints. Each of the M shards receives the same complete copy of query Q.

In step 2, a query planner component of query service 204 of shard machine S_{M} 144 and each of others of the M shard machines 144 performs a query planning process for query Q to estimate the cost of executing query Q (e.g., in terms of fully processing query Q or an amount of computational resources needed to execute query Q) at the respective shard machine S_{M} 144 and to estimate the size of the result set (e.g., number of rows returned or total amount of data returned in bytes) that would be produced by the shard machine S_{M} 144. Each of the others of the M shard machines 144 also performs a similar query planning process for query Q.

In step 3, shard machine S_{M} 144 executes an operation 208 that sends S_{M,}Q metadata to broker machine B_{N} 142. The S_{M,Q} metadata includes the cost and size data generated in step 2 for the particular shard S_{M} and the particular query Q. Each of the others of the M shard machines 144 also sends a similar set of S_{M,Q} metadata to broker machine B_{N} 142.

In step 4, broker machine B_{N} 142 performs a query planning process in which the S_{M,Q} metadata collectively received from all of the M shard machines 144 is evaluated by broker machine B_{N} 142. For example, broker machine B_{N} 142 may compute statistics relating to the cost and/or size estimates received from the M shard machines 144 as part of the S_{M,Q} metadata, such as the average, mean, median, minimum or maximum query cost or result set size. As a result of step 4, broker machine B_{N} 142 computes a limit Lₓ and determines a set of sub-queries

Limit Lₓ is, for example, a processing time limit that is applicable to a round trip x, where x is a positive integer. For example, limit Lₓ may be set to a particular number of milliseconds or microseconds. Alternatively or in addition, limit Lₓ may be expressed as a number of operations to be performed by a shard before returning results generated by that time, which may be partial results. Broker machine B_{N} 142 computes limit Lₓ using the S_{M,Q} metadata. Broker machine 142 may compute a different limit Lₓ for each of the M shard machines or Broker machine 142 may apply the same limit Lₓ to all of the M shard machines 144.

In step 5, broker machine B_{N} 142 executes an operation 210 that communicates the applicable limit Lₓ to the corresponding shard machine S_{M} 144 and to each of the others of the M shard machines 144. For example, broker machine B_{N} 142 may broadcast the same value of limit Lₓ to all of the M shard machines 144. Alternatively, broker machine B_{N} 142 may broadcast different values of limit Lₓ to one or more of the M shard machines 144.

In step 6, broker machine B_{N} 142 executes an operation that divides query Q into i sub-queries where i is a positive integer. Broker machine B_{N} 142 determines how to divide query Q into sub-queries Qᵢ using the S_{M,Q} metadata. For example, broker machine B_{N} 142 may assign sub-queries Qᵢ to shard machines 144 based on the query cost and/or result set size information received by broker machine B_{N} 142 from the shard machines 144 as part of the S_{M,Q} metadata. For instance, if a particular shard machine 144 estimated a much larger result set or a much longer processing time than the others of the M shard machines 144, broker machine B_{N} 142 may assign a smaller sub-query Qᵢ to that particular shard machine 144.

In step 7, broker machine B_{N} 142 executes an operation 212 that assigns and sends a particular sub-query Qᵢ of query Q to shard machine S_{M} 144 and to each of the others of the M shard machines 144. That is, each of the different shard machines 144 receives, from broker machine B_{N} 142, a query processing request for a different sub-query Qᵢ of query Q. Each of the M shard machines 144 can only respond to the sub-query Qᵢ that it has received because the M shard machines are not aware of the communications between broker machine B_{N} 142 and the other shard machines 144. However, the different sub-queries Qᵢ are not necessarily mutually exclusive. In other words, some of the sub-queries Qᵢ may overlap in that they may contain some of the same parts of query Q. In an embodiment, steps 5 and 7 are performed in the same operation to communicate with the shard machines.

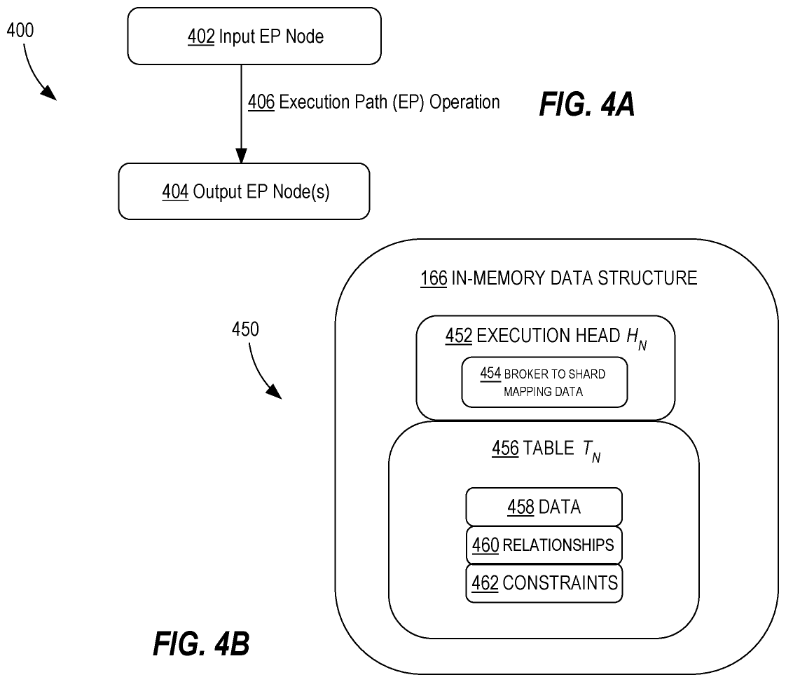

In step 8, a query execution component of query service 204 of shard machine S_{M} 144 and each of others of the M shard machines 144 performs one or more query planning and/or query execution processes on its particular sub-query Qᵢ. The query planning and/or execution processes performed by a particular shard machine S_{M} 144 in step 8 may include, for example, one or more execution path operations on one or more portions of an in-memory data structure 166. Each of the M shard machines 144 may perform different execution path operations and/or a different number of query execution operations and, optionally, a different number of query planning operations, within the limit Lₓ. That is, each of the M shard machines 144 performs as many operations as it can on its particular sub-query Qᵢ up to the limit Lₓ. A shard machine 144 may contain computer code that implements a limit-checking process that periodically checks to see whether the limit Lₓ has been reached and stops the shard machine 144 from performing any further operations if the limit Lₓ has been reached. Examples of execution path operations and an example of an in-memory data structure 166 are shown in FIG. 4A and FIG. 4B, described below.

In step 9, shard machine S_{M} 144 and each of the others of the M shard machines 144 executes an operation 214 that sends a Qᵢ operation list to broker machine B_{N} 142. The Qᵢ operation list contains a list of the query planning and/or query execution operations that were performed in step 8 by the particular shard machine S_{M} 144 within the limit Lₓ. Since each shard machine S_{M} 144 received a different sub-query Qᵢ from broker machine B_{N} 142 in step 7, each shard machine S_{M} 144 sends a different Qᵢ operation list to broker machine B_{N} 142. However, because the sub-queries Qᵢ may have some overlap, the different Qᵢ operation lists also may have some overlap in terms of the operations performed by the respective shard machines 144. In addition to sending the operation list, each shard machine also sends its respective in-memory data structure back to broker machine B_{N} 142 because each in-memory data structure contains a (intermediate) result of the respective sub-query.

In step 10, broker machine B_{N} 142 reads the Qᵢ operation lists received from the M shard machines 144. Based on the query processing operations (e.g., query planning and/or query execution operations) that have been performed by the shards 144 on the sub-queries Qᵢ as indicated by the Qᵢ operation lists, broker machine B_{N} 142 determines whether all of the constraints of query Q have been satisfied. Examples of constraints and satisfaction of constraints are described in more detail below with reference to FIG. 4B.

If broker machine B_{N} 142 determines that all of the constraints have been satisfied, broker machine B_{N} 142 determines that query Q has been resolved and there is no need for another round trip. If all of the constraints have not been satisfied, broker machine B_{N} 142 determines that query Q has not been resolved.

If broker machine B_{N} 142 determines that query Q has not been resolved, broker machine B_{N} 142 may initiate another round trip to further advance the processing of query Q using an adjusted limit Lₓ. For example, broker machine B_{N} 142 may broadcast a new limit Lₓ that is higher or lower, or longer or shorter, than the initial limit Lₓ.

However, it is not necessary for broker machine B_{N} 142 to adjust limit Lₓ for the next round trip. Broker machine B_{N} 142 can increase the number of round trips without adjusting limit Lₓ. Thus, there may be at least two limits: one limit for the number of round trips and one limit Lₓ pertaining to each round trip or a specific round trip. For example, if query Q is a graph query that contains a long chain of edges, and the Qᵢ operation lists indicate to broker machine B_{N} 142 that the shard machines 144 have been processing their respective sub-queries Qᵢ without any performance delays, broker machine B_{N} 142 may simply add another roundtrip while keeping the value of limit Lₓ the same.

This approach of allowing broker machine B_{N} 142 to determine the number of round trips to resolve a query Q and the values of limit Lₓ enables more of the query planning and query execution operations to be distributed to the shard machines 144 while still allowing the broker machine B_{N} 142 to ensure that the distributed query processing of query Q proceeds efficiently. For instance, the disclosed approach prevents shard machines 144 from executing their respective sub-queries Qᵢ with widely varying processing times such that processing time for query Q on the whole is determined by the slowest-performing shard machine 144.

The disclosed approach also enables broker machine B_{N} 142 to assign the sub-queries Qᵢ in accordance with one or more rules that may be implemented at broker machine B_{N} 142 to improve query processing performance. An example of a rule that broker machine B_{N} 142 may use in determining sub-query assignments is that query execution operations that require query result data to be fetched from data storage, e.g., source data stores 150, are to be assigned to shard machines 144 and not to broker machine B_{N} 142. Assigning data fetching operations to shard machines 144 can help improve query processing efficiency because the data to be fetched may be stored on or directly accessible by the shard machines 144.

An example of data fetching operation is a join operation. Join operations can be distributed to shard machines 144 using the disclosed technologies because the in-memory data structures 166 are configured to store ownership information. That is, when broker machine B_{N} 142 assigns a sub-query Qᵢ to a shard machine 144, the shard machine 144 to which the sub-query Qᵢ is assigned is considered the owner of the sub-query, and in-memory data structures 166 at both the broker machine B_{N} 142 and the shard machine 144 store the shard machine-to-sub-query mapping information.

Creating the shard machine to sub-query mapping may include adding one or more disjunctions between edge terms to the in-memory data structure 166. In this way, shard-to-sub-query ownership rules can be predicate-based; e.g., based on predicates rather than on whether the object is a literal or a tuple.

Conversely, another example of a rule that may be implemented by broker machine B_{N} 142 is that query execution operations that do not require query result data to be fetched from data storage are to be assigned to broker machine B_{N} 142 and not to any of the shard machines 144. Examples of non-data fetching operations that can be performed on broker machine B_{N} 142 include an integer addition operation, integer multiplication, and string concatenation.

### Example Query Evaluation Process

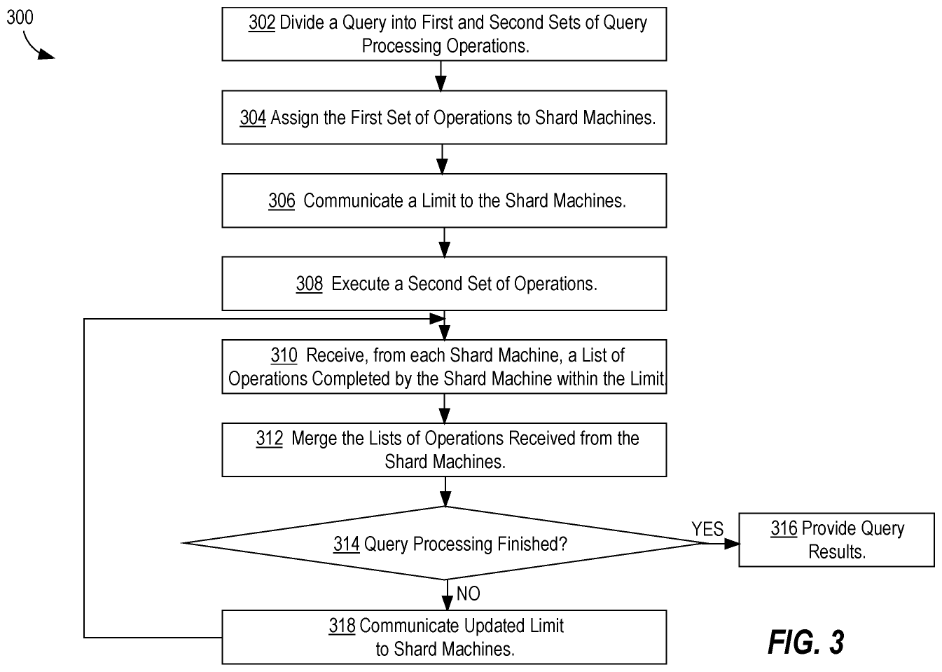

FIG. 3 is a flow diagram of a process that may be used to implement a portion of the computing system of FIG. 1. The operations of a flow 300 as shown in FIG. 3 can be implemented using processor-executable instructions that are stored in computer memory. For purposes of providing a clear example, the operations of FIG. 3 are described as performed by a machine of computing system 100, but other embodiments may use other systems, devices, or implemented techniques. More specifically, flow 200 illustrates operations that may be performed by, for example, query service 160, to evaluate a path query using a decentralized distributed approach.

Operation 302 when executed by one or more machines causes the one or more machines, for example a broker machine of a distributed graph database system, to divide a query into first and second sets of operations for processing the query. Operation 302 may determine the first and second sets of operations based on query processing cost and/or result set size estimations computed by one or more shard machines. Alternatively or in addition, operation 302 may determine the first and second sets of operations based on whether the operations include data-fetching operations or non-data fetching operations.

Prior to dividing the query, operation 302 may include reading the query from a computer memory. The query may be a type of graph query that traverses at least two nodes and at least one edge of a graph in a graph database, e.g., a path query.

Operation 302 may include, for example, reading a string (e.g., alphanumeric text) that has been passed to query service 160 by application software system 170. Operation 302 may include compiling the query into a set of variables and a set of constraints that collectively correspond to the at least two nodes and the at least one edge of the graph, collectively. Alternatively, a process of compiling the query into variables and constraints may be performed prior to operation 302, for example by a query translator/compiler component of query service 160.

Operation 304 when executed by one or more machines causes the one or more machines, e.g., the broker machine, to assign a first set of operations to a set of shards. Assigning the first set of operations to the set of shards may include assigning data fetching operations to the set of shards. Operation 304 also involves and assigning non-data fetching operations to the broker machine and, optionally, other non-data fetching operations to the set of shards. Data fetching operations are costed by the shards. Assigning the first set of operations to the set of shards may include communicating a copy of the set of constraints to each shard of the set of shards and receiving from each shard a query cost and/or result set size estimate computed by the shard based on the set of constraints.

Operation 306 when executed by one or more machines causes the one or more machines, e.g., the broker machine, to communicate a limit to the plurality of shards. Communicating the limit may include the broker machine communicating the same limit value to all shards in the set of shards. For example, communicating the limit may include communicating a limit on processing time for processing the first set of operations to the plurality of shards. Operation 306 may further include the broker machine determining and establishing a value of a round trip limit.

Operation 308 when executed by one or more machines causes the one or more machines, e.g., the broker machine, to execute the second set of operations. Executing the second set of operations may include the broker machine executing non-data fetching operations. In an embodiment, the broker machine performs one or more non-data fetching operations prior to assigning the first set of operations to the set of shards in operation 304.

Operation 310 when executed by one or more machines causes the one or more machines, e.g., the broker machine, to receive, from each shard of the set of shards, a list of operations completed by the shard within the limit established in operation 306. The list of operations completed by a shard may include one or more query planning operations and/or one or more query execution operations. The first set of operations performed by the shards are performed prior to operation 310 and sometime after operation 304. For example, a shard might proceed with performing an operation in the first set of operations only after receiving the limit mentioned with respect to operation 306.

Operation 312 when executed by one or more machines causes the one or more machines, e.g., the broker machine, to merge the lists of operations received from the plurality of shards into a merged set of operations. Operation 314 when executed by one or more machines, causes the one or more machines, e.g., the broker machine, to, using the merged set of operations, determine whether the query processing is finished for the query that was divided in operation 302. Operation 314 may determine that the query processing is finished if all constraints in the set of constraints derived from the query of operation 302 have been resolved.

Operation 316 when executed by one or more machines causes the one or more machines, e.g., the broker machine, to, if the query processing is finished, provide query results in response to the query. For example, operation 316 may provide query results to application software system 170 via an application programming interface (API) of query service 160.

Operation 318 when executed by one or more machines causes the one or more machines, e.g., the broker machine, to, if the query processing is not finished, communicate an updated limit to the set of shards. Communicating an updated limit may include increasing a value of a time limit and communicating the increased time limit value to the set of shards, or decreasing the time limit value and communicating the decreased time limit value to the set of shards. Alternatively or in addition, operation 318 may include, if the query processing is not finished, increasing a value of a round trip limit and increasing or decreasing the value of a time limit or keeping the round trip limit at the same value without changing the value of the time limit. Alternatively, if no data was fetched, then the limit may be updated to a multiple of the cheapest (in terms of cost) unresolved fetch.

### Example Execution Path Operation

The process and data structures of FIGS. 4A-4B represent one way to implement the disclosed broker-shard embodiments. FIG. 4A is a flow diagram of a process that may be used to implement a portion of the computing system of FIG. 1. The operations of a flow 400 as shown in FIG. 4A can be implemented using processor-executable instructions that are stored in computer memory. For purposes of providing a clear example, the operations of FIG. 4A are described as performed by computing system 100, but other embodiments may use other systems, devices, or implemented techniques.

Intermediate results produced by the evaluation of sub-queries may be stored in an in-memory data structure. The in-memory data structure is created dynamically during the query evaluation process for a particular query. As such, the in-memory data structure is not part of the graph or the graph database. The in-memory data structure may include multiple different interrelated tables that each store a set of intermediate query results. Intermediate query results are stored in rows of the tables. Information about the relationships between the tables of the in-memory data structure also may be stored in rows of the tables of the in-memory data structure or using links between rows of different tables in the in-memory data structure.

A path query is a type of query that traverses at least two nodes and at least one edge of the graph in the graph database. Path queries can be computationally expensive because they require multiple different tables to be created in the in-memory data structure that are interrelated by, for example, parent-child relationships. A set of tables and inter-table relationships within the in-memory data structure may be referred to as an execution path. Creating tables and traversing execution paths in the in-memory data structure can increase the processing time and computing resources needed to resolve path queries.

As used herein, a distinction is made between a path query and an execution path. The word path when used in the term path query may refer to a path that a query takes through the graph in the graph database. When used in the term execution path, the word path may refer to a path through an in-memory data structure that is created during execution of a path query.

More specifically, FIG. 4A illustrates an example of an execution path that may be implemented by, for example, query service 160, during the evaluation of a query. The execution path of FIG. 4A includes an input execution path (EP) node 402. EP node 402 includes, for example, a table of an in-memory data structure 166 that is created to store and process intermediate query results and an execution head, which keeps track of changes to the table's execution path that occur as the query is processed. For example, EP node 402 may include a table that stores a set of intermediate query results produced by execution of a first sub-query of an input query. As another example, EP node 402 may be an execution head, which contains table header information for a table that is not yet created.

In the case where input EP node 402 stores a set of intermediate results, an execution path operation 406 is performed on the set of intermediate query results stored in input EP node 402. The result of executing EP operation 406 on the data stored in EP node 402 may be another set of intermediate query results. This second set of intermediate query results, which has been generated or derived from the set of intermediate results stored in EP node 402, is stored in one or more output execution path nodes 404. The number of output EP nodes 404 is determined based on the type of EP operation 406 that is performed on input EP node 402 and also may be determined based on the number of rows of data stored in EP node 402. Examples of EP operations that may be performed on EP nodes are expand, reduce, zip, unzip, and stitch. EP nodes 404 and 402 are linked by a relationship that is defined by EP operation 406. The link between EP node 402 and EP node 404 may be stored in either or both of EP nodes 402, 404.

### Example In-Memory Data Structure

FIG. 4B illustrates an example of in-memory data structures that may be created and processed by a portion of the computing system of FIG. 1. More specifically, FIG. 4B illustrates an example of in-memory data structure 166 that may be created when it has been determined that a query that has been received from, for example, application software system 170, is a path query. In-memory data structure 166 includes an execution head H_{N} 452 and a table T_{N} 456. Execution head H_{N} 452 may be referred to as a real execution head because it is linked to a table, i.e., table 456.

As a query is executed, query service 160 creates EP nodes in the in-memory data structure 166 for the query variables and maps the variables to their corresponding EP nodes. This mapping of EP nodes of the in-memory data structure 166 to query variables is maintained by the execution heads 452.

Execution head 452 illustrates one execution head H_{N} of N execution heads of in-memory data structure 166. That is, in-memory data structure 166 may have any number N of execution heads, where N is a positive integer, and corresponding tables T_{N}.

Execution head 452 stores broker to shard mapping data 454. Broker to shard mapping data 454 includes identifying data for shard machines 144 and respective sub-queries Qᵢ that have been assigned to the shard machines SAJ 144 by a broker machine B_{N} 142. In this way, execution head 452 facilitates the decentralized distributed query evaluation provided by the disclosed technologies.

Table 456 illustrates one table T_{N} of the N tables of in-memory data structure 166. Table 456 includes data 458, relationships 460, and constraints 462. Data 458 includes a set of intermediate query results. Relationships 460 are the inter-table links; i.e., links between rows of different tables. Relationships 460 can be one-to-one or one-to-many. Relationships 460 may store information that identifies the tables that are connected by the link, and may further identify the type of link or relationship between the linked tables. Examples of types of relationships are conjunctive and disjunctive. Conjunctive corresponds to the AND boolean operation or the INTERSECTION set operation. Disjunctive corresponds to the OR boolean operation or the UNION set operation. For example, a row of data 458 may be linked to one or more rows of another table 456 of in-memory data structure 166.

Constraints 462 are limiting criteria that must be satisfied in order for a query to be resolved. Constraints 462 may be applied to variables, where a variable represents a search criterion. In a graph query, a variable may correspond to a node of the graph, an edge, or a predicate. Examples of variables are “employer” and “education.” An example of a constraint on the employer variable is a name of a specific employer, and an example of a constraint on the education variable is a particular type of college degree. A constraint is satisfied if, for example, all rows in the intermediate result set contain data that matches the constraint or there is no row in the intermediate result set that contains data that does not match the constraint. If all constraints 462 are satisfied, the intermediate result set stored in table 456 may become part of a final set of query results that may be returned to, for example, application software system 170.

### Example Path Query Evaluation Process

FIG. 5 is a flow diagram of a process that may be used to implement a portion of the computing system of FIG. 1. The operations of a flow 500 as shown in FIG. 5 can be implemented using processor-executable instructions that are stored in computer memory. For purposes of providing a clear example, the operations of FIG. 5 are described as performed by a machine of computing system 100, but other embodiments may use other systems, devices, or implemented techniques. More specifically, flow 500 illustrates operations that may be performed by, for example, query service 160, to evaluate a path query. Each shard and broker includes a planner 162, an executor 164, and an in-memory data structure 166.

In flow 500, planner 162 reads query constraints and variables 502, which correspond to a path query in graph database 130. A translator/compiler component of query service, not shown, may produce query constraints and variables 502 from an input graph query. That is, an input graph query, which may specify a set of graph nodes, edges, and predicates, is compiled into query constraints and variables 502.

Given query constraints and variables 502, planner 162 determines an order of query evaluation operations 504. To do this, planner 162 may engage in a dynamic planning process in which each possible query evaluation operation is assigned a cost based on, for example, its computational load, and then planner 162 may determine the order of operations to, for example, defer the highest cost operations. Deferring high cost operations is useful because there is a chance that a lower cost operation will make a high cost operation less expensive.

Planner 162 passes order of operations 504 to executor 164. Executor 164 determines and executes execution path operations 508. Execution path operations 508 are determined by executor 164 based on query constraints and variables 502. In this way, executor 164 implements order of operations 504 by applying one or more EP operations 508 to an initial set of intermediate results 506 that have been retrieved from a source data store and stored in a first table in the in-memory data structure 166. Applying an EP operation 508 to the initial set of intermediate results 506 produces a new set of intermediate results 510, which are stored in a new table in the in-memory data structure 166, where the new table has a link to the first table.

Intermediate results 510 may be passed by executor 164 back to planner 162 as results of operations 512. Planner 162 determines whether results of operations 512 are the final set of query results. For example, planner 162 determines whether all constraints associated with intermediate results 510 have been satisfied. If so, planner 162 returns results of operations 512 as final result set 514. If the constraints have not been satisfied, planner re-performs costing and issues new order of operations 504, which in turn initiates a new round of query execution processing by executor 164. Also, a shard's planner 162 has the option to return partial results, as described above.

### Example Hardware Architecture

According to one embodiment, the techniques described herein are implemented by at least one special-purpose computing device. The special-purpose computing device may be hard-wired to perform the techniques, or may include digital electronic devices such as at least one application-specific integrated circuit (ASIC) or field programmable gate array (FPGA) that is persistently programmed to perform the techniques, or may include at least one general purpose hardware processor programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, mobile computing devices, wearable devices, networking devices or any other device that incorporates hard-wired and/or program logic to implement the techniques.

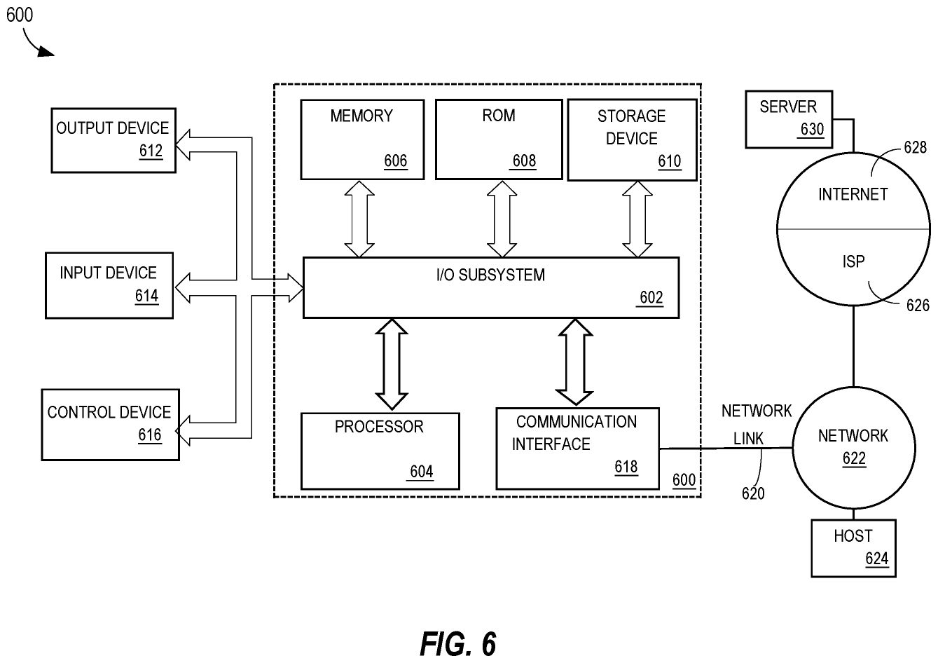

For example, FIG. 6 is a block diagram that illustrates a computer system 600 upon which an embodiment of the present invention may be implemented. Computer system 600 includes a bus 602 or other communication mechanism for communicating information, and a hardware processor 604 coupled with bus 602 for processing information. Hardware processor 604 may be, for example, a general-purpose microprocessor.

Computer system 600 also includes a main memory 606, such as a random-access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory computer-readable storage media accessible to processor 604, render computer system 600 into a special-purpose machine that is customized to perform the operations specified in the instructions.

Computer system 600 and further includes a read only memory (ROM) 608 or other static storage device coupled to bus 602 for storing static information and instructions for processor 604. A storage device 610, such as a magnetic disk or optical disk, is provided and coupled to bus 602 for storing information and instructions.

Computer system 600 may be coupled via bus 602 to an output device 612, such as a display, such as a liquid crystal display (LCD) or a touchscreen display, for displaying information to a computer user, or a speaker, a haptic device, or another form of output device. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, at least one ASIC or FPGA, firmware and/or program logic which in combination with the computer system causes or programs computer system 600 to be a special-purpose machine. According to one embodiment, the techniques herein are performed by computer system 600 in response to processor 604 executing at least one sequence of instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 610. Volatile media includes dynamic memory, such as main memory 606. Common forms of storage media include, for example, a hard disk, solid state drive, flash drive, magnetic data storage medium, any optical or physical data storage medium, memory chip, or the like.

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying at least one sequence of instruction to processor 604 for execution. For example, the instructions may initially be carried on a magnetic disk or solid-state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated-services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through at least one network to other data devices. For example, network link 620 may provide a connection through local network 622 to a host computer 624 or to data equipment operated by an Internet Service Provider (ISP) 626. ISP 626 in turn provides data communication services through the world-wide packet data communication network commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 530 might transmit a requested code for an application program through Internet 628, ISP 626, local network 622 and communication interface 618. The received code may be executed by processor 604 as it is received, and/or stored in storage device 610, or other non-volatile storage for later execution.

### ADDITIONAL EXAMPLES

Illustrative examples of the technologies disclosed herein are provided below. An embodiment of the technologies may include any of the examples or a combination of the described below.

In an example 1, a method is performed by a broker machine of a distributed graph database system and includes: dividing a query into first and second sets of operations for processing the query, where the query comprises a set of variables and a set of constraints that correspond to at least two nodes and at least one edge of a graph in a graph database; assigning the first set of operations to a plurality of shards; communicating a limit to the plurality of shards; executing the second set of operations; receiving, from each shard of the plurality of shards, a list of operations completed by the shard within the limit; merging the lists of operations received from the plurality of shards into a merged set of operations; using the merged set of operations, determining whether the query processing is finished; if the query processing is not finished, communicating an updated limit to the plurality of shards; and if the query processing is finished, providing query results in response to the query.

An example 2 includes the subject matter of example 1, further including where assigning the first set of operations to the plurality of shards comprises assigning data fetching operations to the plurality of shards. An example 3 includes the subject matter of example 2, further including where executing the second set of operations comprises executing non-data fetching operations.

An example 4 includes the subject matter of any of examples 1-3, further including where communicating the limit comprises communicating a same limit to all shards in the plurality of shards. An example 5 includes the subject matter of any of examples 1-4, further including where communicating the limit comprises communicating an updated time limit to the plurality of shards. An example 6 includes the subject matter of example 5, further including where communicating the updated limit comprises (a) increasing the time limit and communicating the increased time limit to the plurality of shards or (b) decreasing the time limit and communicating the decreased time limit to the plurality of shards.

An example 7 includes the subject matter of any of examples 1-6, further including where the limit is a first limit, further comprising establishing a second limit that is different than the first limit, where the second limit is a round trip limit. An example 8 includes the subject matter of example 7, further including, if the query processing is not finished, increasing the round trip limit and increasing or decreasing the first limit.

An example 9 includes the subject matter of any of examples 1-8, further including where assigning the first set of operations to the plurality of shards comprises communicating a copy of the set of constraints to each shard of the plurality of shards. An example 10 includes the subject matter of any of examples 1-9, further including using the merged set of operations to update the set of constraints and using the updated set of constraints to determine whether the query processing is finished.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions set forth herein for terms contained in the claims may govern the meaning of such terms as used in the claims. No limitation, element, property, feature, advantage or attribute that is not expressly recited in a claim should limit the scope of the claim in any way. The specification and drawings are to be regarded in an illustrative rather than a restrictive sense.

Terms such as “computer-generated” and “computer-selected” as may be used herein may refer to a result of an execution of one or more computer program instructions by one or more processors of, for example, a server computer, a network of server computers, a client computer, or a combination of a client computer and a server computer.

As used here, “online” may refer to a particular characteristic of a connections network-based system. For example, many connections network-based systems are accessible to users via a connection to a public network, such as the Internet. However, certain operations may be performed while an “online” system is in an offline state. As such, reference to a system as an “online” system does not imply that such a system is always online or that the system needs to be online in order for the disclosed technologies to be operable.

As used herein the terms “include” and “comprise” (and variations of those terms, such as “including,” “includes,” “comprising,” “comprises,” “comprised” and the like) are intended to be inclusive and are not intended to exclude further features, components, integers or steps.

Various features of the disclosure have been described using process steps. The functionality/processing of a given process step potentially could be performed in different ways and by different systems or system modules. Furthermore, a given process step could be divided into multiple steps and/or multiple steps could be combined into a single step. Furthermore, the order of the steps can be changed without departing from the scope of the present disclosure.

It will be understood that the embodiments disclosed and defined in this specification extend to alternative combinations of the individual features mentioned or evident from the text or drawings. These different combinations constitute various alternative aspects of the embodiments.

What is claimed is:

1. A method performed by a broker machine of a distributed graph database system, the method comprising:
dividing a query into first and second sets of operations for processing the query;
the query comprising a set of variables and a set of constraints that correspond to at least two nodes and at least one edge of a graph in a graph database;
assigning the first set of operations to a plurality of shards;
communicating a limit to the plurality of shards;
executing the second set of operations;
receiving, from each shard of the plurality of shards, a list of operations completed by the shard within the limit;
merging the lists of operations received from the plurality of shards into a merged set of operations;
using the merged set of operations, determining whether the query processing is finished;
if the query processing is not finished, communicating an updated limit to the plurality of shards;
if the query processing is finished, providing query results in response to the query.

2. The method of claim 1, wherein assigning the first set of operations to the plurality of shards comprises assigning data fetching operations to the plurality of shards.

3. The method of claim 2, wherein executing the second set of operations comprises executing non-data fetching operations.

4. The method of claim 1, wherein communicating the limit comprises communicating a same limit to all shards in the plurality of shards.

5. The method of claim 1, wherein communicating the limit comprises communicating an updated time limit to the plurality of shards.

6. The method of claim 5, wherein communicating the updated limit comprises (a) increasing the time limit and communicating the increased time limit to the plurality of shards or (b) decreasing the time limit and communicating the decreased time limit to the plurality of shards.

7. The method of claim 1, wherein the limit is a first limit, further comprising establishing a second limit that is different than the first limit, wherein the second limit is a round trip limit.

8. The method of claim 7, further comprising, if the query processing is not finished, increasing the round trip limit and increasing or decreasing the first limit.

9. The method of claim 1, wherein assigning the first set of operations to the plurality of shards comprises communicating a copy of the set of constraints to each shard of the plurality of shards.

10. The method of claim 1, further comprising using the merged set of operations to update the set of constraints and using the updated set of constraints to determine whether the query processing is finished.

11. At least one non-transitory machine-readable storage medium comprising instructions which, when implemented by at least one machine, cause the at least one machine to perform operations comprising:
dividing a query into first and second sets of operations;
the query comprising a set of variables and a set of constraints that correspond to at least two nodes and at least one edge of a graph in a graph database;
assigning the first set of operations for processing the query to a plurality of shards;
communicating a limit to the plurality of shards;
executing the second set of operations for processing the query;
receiving, from each shard of the plurality of shards, a list of operations completed by the shard within the limit;
merging the lists of operations received from the plurality of shards into a merged set of operations;
using the merged set of operations, determining whether the query processing is finished;
if the query processing is not finished, communicating an updated limit to the plurality of shards;
if the query processing is finished, providing query results in response to the query.

12. The at least one non-transitory machine-readable storage medium of claim 11, wherein assigning the first set of operations to the plurality of shards comprises assigning data fetching operations to the plurality of shards.

13. The at least one non-transitory machine-readable storage medium of claim 12, wherein executing the second set of operations comprises executing non-data fetching operations.

14. The at least one non-transitory machine-readable storage medium of claim 11, wherein communicating the limit comprises communicating a same limit to all shards in the plurality of shards.

15. The at least one non-transitory machine-readable storage medium of claim 11, wherein communicating the limit comprises communicating an updated time limit to the plurality of shards.

16. The at least one non-transitory machine-readable storage medium of claim 15, wherein communicating the updated limit comprises (a) increasing the time limit and communicating the increased time limit to the plurality of shards or (b) decreasing the time limit and communicating the decreased time limit to the plurality of shards.

17. The at least one non-transitory machine-readable storage medium of claim 11, wherein the limit is a first limit, further comprising instructions which, when implemented by at least one machine, cause the at least one machine to perform operations comprising establishing a second limit that is different than the first limit, wherein the second limit is a round trip limit.

18. The at least one non-transitory machine-readable storage medium of claim 17, further comprising instructions which, when implemented by at least one machine, cause the at least one machine to perform operations comprising, if the query processing is not finished, increasing the round trip limit and increasing or decreasing the first limit.

19. The at least one non-transitory machine-readable storage medium of claim 11, wherein assigning the first set of operations to the plurality of shards comprises communicating a copy of the set of constraints to each shard of the plurality of shards.

20. The at least one non-transitory machine-readable storage medium of claim 11, further comprising instructions which, when implemented by at least one machine, cause the at least one machine to perform operations comprising using the merged set of operations to update the set of constraints and using the updated set of constraints to determine whether the query processing is finished.
